(19) United States
(12) Patent Application Publication
(10) Pub. No.: US 2026/0295599 A1
(43) Pub. Date: Oct. 1, 2026

(54) A METHOD OF OPERATING A CENTRIFUGAL SEPARATOR

(71) Applicant: Alfa Laval Corporate AB, LUND (SE)

(72) Inventors: Shota NOZADZE, STOCKHOLM (SE); Magnus SUNDIN, STOCKHOLM (SE)

(73) Assignee: Alfa Laval Corporate AB, LUND (SE)

(21) Appl. No.: 19/488,944

(22) PCT Filed: May 23, 2024
(86) PCT No.: PCT/EP2024/064190

§ 371 Date: Dec. 1, 2025

(30) Foreign Application Priority Data
Jun. 20, 2023 (EP) 23180333.9

(51) Int. Cl. B04B 1/08; B04B 5/04; B04B 15/02

(52) U.S. Cl. CPC B04B 1/08; B04B 5/04; B04B 15/02

(57) ABSTRACT

The present invention provides a method of operating a centrifugal separator. The centrifugal separator comprises a centrifuge bowl arranged to rotate around an axis of rotation and in which the separation of a liquid mixture takes place, a stationary hood which defines at least part of a surrounding space in which said centrifuge bowl is arranged, a drive member configured to rotate the centrifuge bowl around the axis of rotation. The centrifuge bowl further comprises an inlet for receiving the liquid mixture to be separated and at least one liquid outlet for discharging a separated liquid phase. The method comprises the steps of a) separating the liquid feed mixture into at least one separated liquid phase in the centrifuge bowl; b) supplying water from a collection tank to the centrifugal separator for cooling said stationary hood; c) collecting the supplied water from step b) in said collection tank after cooling said stationary hood and d) resupplying water from the collection tank to the centrifugal separator for cooling said stationary hood such that a circulation loop of water is formed between the centrifugal separator and said collection tank.

### FIELD OF THE INVENTION

The present invention relates to the field of centrifugal separators, and more specifically to a method of operating a centrifugal separator.

### BACKGROUND OF THE INVENTION

Centrifugal separators are generally used for separation of liquids and/or for separation of solids from a liquid. During operation, liquid mixture to be separated is introduced into a rotating bowl and heavy particles or denser liquid, usually water, accumulates at the periphery of the rotating bowl whereas less dense liquid accumulates closer to the central axis of rotation. This allows for collection of the separated fractions, e.g. by means of different outlets arranged at different distances from the rotational axis.

However, during operation of a centrifugal separator, a lot of water is consumed. This may be water used for cooling the hood of the separator, for cooling the motor, such as the gear box of the motor. Further, if the centrifugal separator is hermetically sealed with mechanical seals, water may also be needed and consumed for cooling the sealings. Also, some centrifugal separators are equipped with intermittent discharge ports at the periphery of the separator bowl. These are used for intermittently discharging accumulated sludge from the bowl to a space between the rotating bowl and the stationary hood. Such space then needs to be flushed with water in order to prevent build-up of discharged sludge within the hood. Thus, there is a need in the art for methods and systems for decreasing the water consumption of a centrifugal separator.

### SUMMARY OF THE INVENTION

It is an object of the invention to at least partly overcome one or more limitations of the prior art. In particular, it is an object to provide a method of operating a centrifugal separator that leads to a reduced water consumption.

As a first aspect of the invention, there is provided a method of operating a centrifugal separator, wherein the centrifugal separator comprises
a centrifuge bowl arranged to rotate around an axis of rotation (X) and in which the separation of a liquid mixture takes place,
a stationary hood which defines at least part of a surrounding space in which the centrifuge bowl is arranged,
a drive member configured to rotate the centrifuge bowl around the axis of rotation (X), wherein
the centrifuge bowl further comprises an inlet for receiving the liquid mixture to be separated and at least one liquid outlet for discharging a separated liquid phase,
wherein the method comprises the steps of
   a) separating the liquid feed mixture into at least one separated liquid phase in the centrifuge bowl;
   b) supplying water from a collection tank to the centrifugal separator for cooling the stationary hood;
   c) collecting the supplied water from step b) in the collection tank after cooling the stationary hood;
   d) resupplying water from the collection tank to the centrifugal separator for cooling the stationary hood such that a circulation loop of water is formed between the centrifugal separator and the collection tank.

The centrifugal separator may be a disc-stack centrifugal separator, e.g. as disclosed in US20210107014.

The method is a method for decreasing the water consumption during operation of the centrifugal separator.

Step a) of separating the liquid feed mixture may comprise supplying the liquid feed mixture to the inlet of the centrifugal separator and discharging at least one separated liquid phase from the outlet the centrifugal separator. Step a) may comprise separating the liquid feed mixture into two liquid phases of different density. The at least one liquid phase is preferably not reintroduced to the centrifugal separator.

Step b) of supplying water from a collection tank may comprises pumping water from the collection tank to the centrifugal separator. The collection tank may be arranged outside of the stationary hood. The water supplied in step b) may be pressurized water, such as having a pressure of above 1.5, such as above 2 bar. The water supplied in step b) is for cooling the stationary hood. The stationary hood may thus have a cooling jacket, such as a double wall, through which the water may flow. Water supplied in step b) may thus be supplied so as not to contact the rotating centrifuge bowl, i.e. supplying water in step b) may not comprise spraying cooling water to the centrifuge bowl.

The water supplied in step b) for cooling the stationary hood is preferably water that is not part of the liquid feed mixture or any separated liquid phase or phases. The cooling water in step b) may thus be part of a cooling water system that is separate from the liquid feed mixture and any separated liquid phase or phases.

In embodiments, the water supplied in step b) is not used for cooling any mechanical seal of the centrifugal separator.

Thus, in step c) any water that has been used for sealing liquid or cooling liquid in any mechanical seal of the centrifugal separator may not be collected in the collection tank and therefore not be used in the circulation loop.

Step c) of collecting the water thus comprises sending the water back to the collection tank, i.e. the water used for cooling the hood is collected in the collection tank from which it was supplied.

Step d) of resupplying water thus means recirculating the water that has already been used for cooling the stationary hood so that it yet again may be used for cooling the hood. A circulation loop for the water is thus formed between the collection tank and the centrifugal separator. However, all water that is collected in step c) does not need to be recirculated or resupplied in step d).

The first aspect of the invention is based on the insight that since the water used for cooling the stationary frame is not in contact with any feed or product, this may be reused and thereby decrease the overall water consumption of the centrifugal separator.

In embodiments of the first aspect of the invention, the water supplied to the centrifugal separator in step b) is also used for cooling a portion of the drive member.

The portion of drive member that is cooled is thus a portion of the motor used for rotating the centrifuge bowl around the axis of rotation (X). The drive member that is cooled may hence not be the rotatable shaft onto which the centrifuge bowl may be mounted.

Thus, step b) may include supplying water from a collection tank to the centrifugal separator for cooling the stationary hood, step c) may include collecting the supplied water from step b) in the collection tank after cooling the stationary hood and the portion of the drive member, and step d) may comprise resupplying water from the collection tank to the centrifugal separator for cooling the stationary hood and portion of the drive member such that a circulation loop of water is formed between the centrifugal separator and the collection tank.

The inventors have thus found that also water cooling the drive member can be recirculated and be in the same circulation loop as the water cooling the stationary frame.

As an example, water supplied to the centrifugal separator in step b) may also be used for cooling a portion of the drive member before cooling the stationary hood, or vice versa. The water used for cooling the potion of the drive member may thus be used for cooling the stationary hood before it is collected in the collection tank. As an alternative, the water used for cooling the stationary hood may thus be used for cooling the potion of the drive member the stationary hood before it is collected in the collection tank.

The drive member may be a drive motor for rotating a spindle onto which the centrifuge bowl is mounted. The drive member may be connected to the spindle via a transmission means in the form of a worm gear which comprises a pinion and an element connected to the spindle in order to receive driving torque. The transmission means may alternatively take the form of a propeller shaft, drive belts or the like, and the drive motor may alternatively be an electric motor, which may be connected directly to the spindle.

Thus, the portion of the drive member may for example be a gear box of the drive member.

In embodiments of the first aspect, step b) further comprises supplying water to the centrifugal separator from the circulation loop to flush the surrounding space.

Thus, the water in the formed circulation loop may also be used for cleaning the space outside of the centrifuge bowl, so called flushing.

As an example, the water supplied to flush the surrounding space may not reintroduced in the circulation loop. In other words, the water used for such flushing of the surrounding space is not collected in the collection tank. This is because such water may be contaminated with separated sludge.

In embodiments of the first aspect, the centrifugal separator further comprises an intermittent discharge system for discharging a separated sludge phase from the centrifuge bowl to the surrounding space. Step b) may then further comprise supplying water from the circulation loop to the intermittent discharge system.

The centrifugal separator may thus also be arranged for discharging a sludge phase, i.e. a separated sludge phase that may also contain some liquid, to the surrounding space around the centrifuge bowl. This is performed by an intermittent discharge system comprising sludge outlets at the periphery of the centrifuge bowl. The sludge outlets may be in the form of a set of ports arranged to be opened intermittently during operation. The centrifugal separator may be arranged for emptying a partial content of the bowl during such an intermittent discharge (partial discharge) or arranged for emptying the whole content of the centrifuge bowl during intermittent discharge (full discharge).

The intermittent discharge system thus controls the opening of the sludge outlets. For this purpose, the intermittent discharge system may comprise a an operating slide that is movable between a closed position, in which the sludge outlets are closed, and an open position, in which the sludge outlets are open. Keeping the operating slide in a closed position may be effected by supplying water via a channel to a closing chamber between the operating slide and the frame in order to hold the operating slide in the closed position. The intermittent discharge system may further comprise an opening chamber, to which water is supplied when to change the operating slide to its open position. The intermittent discharge system may thus comprise sludge outlets and an operating slide arranged within the centrifuge bowl to open and close the sludge outlets.

As an example, the water supplied from the circulation loop to the intermittent discharge system in step b) may be supplied to an operating water module (OWM) of the intermittent discharge system. Such an OWM may be arranged to supply an amount of water to the centrifugal separator to open and/or close the sludge outlets.

Thus, the inventors have also found that the water being recirculated may be used by the intermittent discharge system when needed for opening and closing the sludge outlets. This may be convenient since the water in the circulation loop may be pressurised and ready to use.

As an example, the water supplied to the intermittent discharge system may not be reintroduced in the circulation loop. This is because such water may be contaminated with liquid feed or separated product.

Supplying water for cooling the stationary hood and/or a portion of the drive member may be performed mor or less continuously during operation of the centrifugal separator, i.e. during separation of the liquid feed mixture, whereas water supplied to the intermittent discharge system may be performed at specific time points or during short time intervals, i.e. during time intervals in the separation process when such water is needed. Since the circulation loop may give a continuous supply of pressurized water, it is convenient for the intermittent discharge system to utilize such water when needed.

In embodiments of the first aspect of the invention, step d) comprises the sub steps of
d1) determining the temperature of the water to be resupplied;
d2) determining if the temperature is above a threshold value and if so, supplying external water to the collection tank to lower the temperature; and then
d3) resupplying water from the collection tank to the centrifugal separator for cooling the stationary hood.

Consequently, the temperature of the water that is used for cooling may be determined, either continuously or at some frequency, in order to see that the temperature has not risen above an acceptable level. If the temperature is too high, external water, such as tap water, may be introduced in the collection tank. Such external water may thus have a lower temperature than the average temperature in the circulation loop. Any excess water in the collection tank may be disposed of.

In embodiments of the first aspect of the invention, the method is further comprising the steps of
e) determining the water level in the collection tank;
f) determining if the water level is below a threshold value and if so, supplying external water to the collection tank to increase the water level in the collection tank.

Thus, determining the water level and making sure that it is above some threshold reduces the risk of running out of water in the circulation loop if for example a lot of water has been used for flushing or to the intermittent discharge system, or if water I the circulation loop has been heated and need to be disposed of.

As a second aspect of the invention, there is provided a centrifugal separation system for separating at least one liquid phase and a sludge phase from a liquid feed mixture. The separation system comprises a centrifugal separator and a recirculation unit. The centrifugal separator comprises
a centrifuge bowl arranged to rotate around an axis of rotation (X) and in which the separation of the liquid mixture takes place,
a stationary hood which defines at least part of a surrounding space in which the centrifuge bowl is arranged,
a drive member configured to rotate the centrifuge bowl around the axis of rotation (X),
wherein the centrifuge bowl further comprises an inlet for receiving the liquid mixture to be separated and at least one liquid outlet for discharging a separated liquid phase.

The recirculation unit comprises a collection tank or water to be supplied to the centrifugal separator and a pump for pumping water from the collection tank to the centrifugal separator.

The centrifugal separation system is arranged such that a circulation loop for water is formed between the collection tank and the stationary hood of the centrifugal separator.

This aspect may generally present the same or corresponding advantages as the former aspect. Effects and features of this second aspect are largely analogous to those described above in connection with the first aspect. Embodiments mentioned in relation to the first aspect are largely compatible with the second aspect.

The centrifugal separator may be operated according to the method of the first aspect. The centrifugal separator is for separation of a liquid feed mixture. The liquid feed mixture may be an aqueous liquid or an oily liquid. As an example, the centrifugal separator may be for separating solids and one or two liquids from the liquid feed mixture.

The centrifuge bowl encloses by rotor walls a separation space. The separation space, in which the separation of the fluid mixture takes place, may comprise separation members, such as a stack of separation discs. The separation discs may e.g. be of metal. Further, the separation discs may be frustoconical separation discs, i.e. having separation surfaces forming frustoconical portions of the separation discs. The separation discs may be arranged coaxially around the axis of rotation (X) at a distance from each other such that to form passages between each two adjacent separation discs.

The centrifuge bowl of the separator may be arranged to be rotated around vertical axis of rotation, i.e. the axis of rotation (X) may extend vertically. The centrifuge bowl is usually supported by a spindle, i.e. a rotating shaft, and may thus be mounted to rotate with the spindle. Consequently, the centrifugal separator may comprise a spindle that is rotatable around the axis of rotation (X). The centrifugal separator may be arranged such that the centrifuge bowl is supported by the spindle at one of its ends, such at the bottom end or the top end of the spindle.

The stationary hood may comprise a cooling jacket, such as a double wall through which water can flow. The stationary hood is thus a non-rotating part.

The drive member may be as discussed in relation to the first aspect above. Thus, the drive member may comprise an electrical motor and/or may be provided beside the spindle and rotate the rotating part by a suitable transmission, such as a belt or a gear transmission.

The centrifugal separator also comprises an inlet for liquid mixture to be separated (the liquid feed mixture). This inlet may be arranged for receiving the liquid feed mixture and be arranged centrally in the centrifuge bowl, thus at rotational axis (X). The centrifuge bowl may be arranged to be fed from the bottom, such as through a spindle, so that the liquid feed mixture is delivered to the inlet from the bottom of the separator. However, the centrifuge bowl may also be arranged to be fed from the top, such as through a stationary inlet pipe extending into the bowl.

Further, also one or two liquid outlets may be arranged at the top or the bottom of the centrifugal separator and a sludge outlet.

The recirculation unit comprises a collection tank and a pump. The tank may be a tank suitable for holding at least 30 litres, such as at least 50 litres of water. The tank may be a plastic food grade tank.

The separation system is further arranged such that a circulation loop is formed between the collection tank and the centrifugal separator. The pump is thus used for pumping water in the circulation loop.

The circulation loop may thus comprise pipes for directing water to and from the centrifugal separator and the collection tank, as well as channels within the centrifugal separator, such as channels within the stationary hood.

In embodiments of the second aspect, the circulation loop is also arranged for cooling a portion of the drive member. Such portion may be a gear box.

The circulation loop may thus comprise pipes for supplying water from the collection tank to the centrifugal separator, channels within the centrifugal separator for directing the supplied water through the stationary hood and also possibly through channels that are in thermal contact with a portion of the drive member, as well as pipes for returning the supplied water back to the collection tank.

In embodiments of the second aspect of the invention, the centrifugal separator further comprises a flushing member for flushing the surrounding space, and wherein the flushing member is connected to the circulation loop.

The flushing member may for example be a nozzle arranged for flushing water through the surrounding space, i.e. through the space and walls of the stationary hood that surrounds the centrifuge bowl. Such flushing member may be connected to the circulation loop e.g. via a pipe branching off from the circulation loop and a valve at the branching position. The valve may thus be used to direct water from the circulation loop to the flushing member when needed during the separation process.

Furthermore, the separation system may be arranged so as to not reintroduce the flush water to the circulation loop. Thus, water that has passed the flushing member may not be reintroduced to the circulation loop.

In embodiments of the second aspect, the centrifugal separator further comprises an intermittent discharge system for discharging a separated sludge phase from the centrifuge bowl to the surrounding space, and wherein the intermittent discharge system is connected to the circulation loop.

The intermittent discharge system may be as discussed in relation to the first aspect above.

As an example, the intermittent discharge system, such as an OWM, may be connected to the circulation loop e.g. via a pipe branching off from the circulation loop and a valve at the branching position. The valve may thus be used to direct water from the circulation loop to the intermittent discharge system when needed during the separation process.

In embodiments of the second aspect, the collection tank comprises an inlet for external water and the recirculation unit further comprises a temperature sensor arranged for measuring the temperature of the water in the circulation loop and a control unit operable to control the inflow of external water to the collection tank via the inlet based on information from the temperature sensor.

The temperature sensor may be arranged for measuring the water in the collection tank or the water leaving the collection tank. The temperature sensor may for example be arranged between the collection tank and the pump.

The control unit may comprise any suitable type of programmable logical circuit, processor circuit, or microcomputer, e.g. a circuit for digital signal processing (digital signal processor, DSP), a Central Processing Unit (CPU), a processing unit, a processing circuit, a processor, an Application Specific Integrated Circuit (ASIC), a microprocessor, or other processing logic that may interpret and execute instructions. Thus, the control unit may comprise a processor and an input/output interface for communicating with the temperature sensor for receiving information about a measured temperature of the water and for controlling the inflow of external water to the collection tank, such as controlling a valve that regulates the inflow of external water to the collection tank.

Thus, the control unit may be operable to perform the steps d1) and d2) discussed in relation not the first aspect above, i.e. the steps of
d1) determining the temperature of the water to be resupplied;
d2) determining if the temperature is above a threshold value and if so, supplying external water to the collection tank to lower the temperature.

The control unit may also be operable to control the pump of the recirculation unit, i.e. operable to control the step b) of
b) supplying water from a collection tank to the centrifugal separator for cooling the stationary hood;
and step d) of
d) resupplying water from the collection tank to the centrifugal separator for cooling the stationary hood such that a circulation loop of water is formed between the centrifugal separator and the collection tank

In embodiments of the second aspect, the collection tank comprises an inlet for external water and a level sensor, and wherein the recirculation unit further comprises a control unit operable to control the inflow of external water to the collection tank via the inlet based on information from the level sensor.

Thus, the control unit as discussed above may be operable to receive information about the water level in the tank from the level sensor, and based on that information decide if refill of external water, such as tap water, is needed.

In embodiments of the second aspect, the recirculation unit is a stand-alone, single unit. As an example, the stand-alone, single unit may comprise a support structure onto which the pump and collection tank is arranged.

Thus, the recirculation unit with its collection tank and pump may be arranged on the same structure. The support structure may be a moveable structure. This is advantageous in that the recirculation unit may be connected directly to already installed centrifugal separators and may give rise to a small footprint. This may be an advantage in e.g. smaller factories or breweries where any type of central recirculation system is not feasible. The support structure may for example be equipped with wheels for facilitating moving of the whole recirculation unit.

As a third aspect of the invention, there is provided the recirculation unit as such as discussed in relation to the second aspect above.

### BRIEF DESCRIPTION OF THE DRAWINGS

The above, as well as additional objects, features and advantages of the present inventive concept, will be better understood through the following illustrative and non-limiting detailed description, with reference to the appended drawings. In the drawings like reference numerals will be used for like elements unless stated otherwise.

FIG. 1 shows a schematic drawing of a centrifugal separator according to an embodiment of the present invention.

FIG. 2 shows a schematic drawing of a centrifugal separation system according to an embodiment of the present invention.

FIG. 3 shows a flow chart of a method of operating a centrifugal separator.

### DETAILED DESCRIPTION

The method and the centrifugal separation system according to the present disclosure will be further illustrated by the following description with reference to the accompanying drawings.

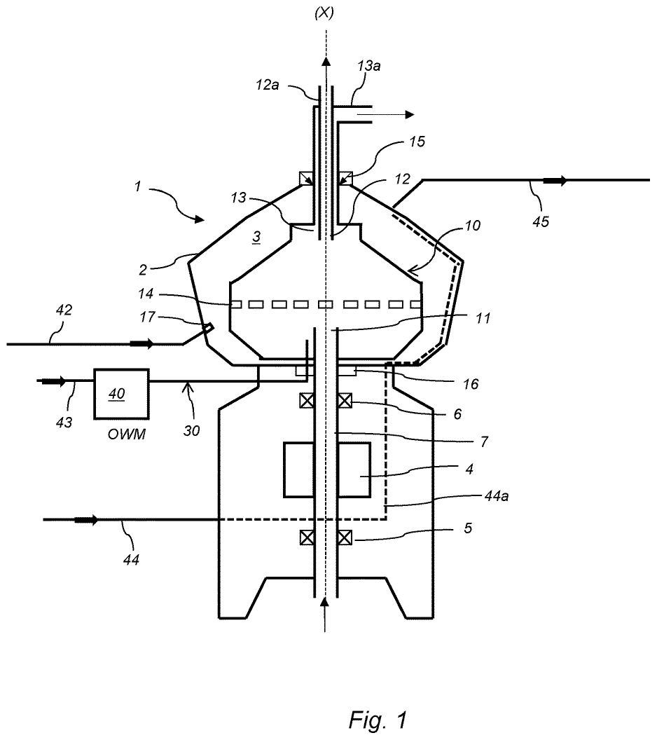

FIG. 1 show a cross-section of an embodiment of a centrifugal separator 1 which in this embodiment is arranged to separate a sludge phase, a liquid heavy phase and a liquid light phase from a liquid feed mixture.

The centrifugal separator 1 comprises a centrifuge bowl 10 which is arranged to rotate around an axis of rotation (X) together with spindle 7 onto which the bowl 10 is mounted. The spindle 7 is supported a bottom bearing 5 and a top bearing 6. The centrifuge bowl 10 is attached the upper portion of the spindle 7 and forms within itself a separation chamber in which centrifugal separation of the liquid feed mixture takes place during operation. The separation chamber within the centrifuge bowl 10 may be provided with a stack of frustoconical separation discs in order to achieve effective separation of the liquid feed mixture, such as separation discs disclosed in EP3315203.

Further, the separator 1 comprises a stationary hood 2 that surrounds at least the upper portion of the centrifuge bowl 10. The hood 2 thus defines at least part of a surrounding space 3 in which the centrifuge bowl 10 is arranged.

The spindle 7 is in this example a hollow spindle for introducing the liquid feed mixture to the inlet 11 of the centrifuge bowl 10. The centrifuge bowl 10 further comprises a liquid outlet 12 for discharging a separated liquid light phase and a liquid outlet 13 for discharging a liquid heavy phase. The liquid light phase outlet 12 is arranged at a smaller radius than the liquid heavy phase outlet 13. There is further a stationary outlet pipe 12a connected to the liquid light phase outlet 12 for receiving the separated liquid light phase, and a stationary outlet pipe 13a connected to the liquid heavy phase outlet 13 for receiving the separated liquid heavy phase.

The centrifuge bowl 10 further comprises a sludge outlet 14 for discharging a separated sludge phase to the surrounding space 3, which is sealed relative the surroundings of the hood 2. The sludge outlet 14 takes the form of a set of intermittently openable sludge outlets arranged at the outer periphery of the centrifuge bowl 10 for discharge of sludge from a radially outer portion of the separation chamber within the bowl 10 to the surrounding space 3. The sludge outlets 14 form part of the intermittent discharge system 30, which also comprises an axially movable operating slide (not shown) arranged in the centrifuge bowl 10, as known in the art.

The opening of the sludge outlets 14 of the intermittent discharge system 30 is controlled by means of an operating slide actuated by operating water supplied to the centrifuge bowl by an operating water module (OWM) 30. The operating slide is movable between a closed position in which the sludge outlets 14 are closed, and an open position, in which sludge outlets 14 are open. The OWM 40 comprises a compressed air unit which in turn forces a piston to push water from the OWM 40 to the centrifuge bowl 10. During operation, water supplied by the OWM 30 may act on the operating slide to close the outlets 14. The draining of the water and thereby opening of the sludge outlets 14 may also be initiated by introducing water from the OWM 30.

The centrifugal separator 1 further comprises a drive motor 4 configured to rotate the centrifuge bowl 10 in relation around the axis of rotation (X). The drive motor 4 may be connected directly to the spindle 7 or connected to the spindle 7 via a transmission means. The drive motor 4 may comprise a gear box.

The surrounding space 3 is sealed relative the surroundings of the hood 2 by means of an upper seal 15 and a lower seal 16. The upper seal 15 may be an outlet seal that seals the liquid outlets from the surroundings. If thee centrifugal separator is arranged with a stationery inlet pie extending into the centrifuge bowl from the top, the upper seal 15 could also be the seal that seals the inlet from the surroundings.

The upper seal 15 could for example be a mechanical seal or a liquid seal. Also the lower seal 16 could be a mechanical seal or a liquid seal. One or both of the upper 15 and lower seal 16 could be a hermetic seal.

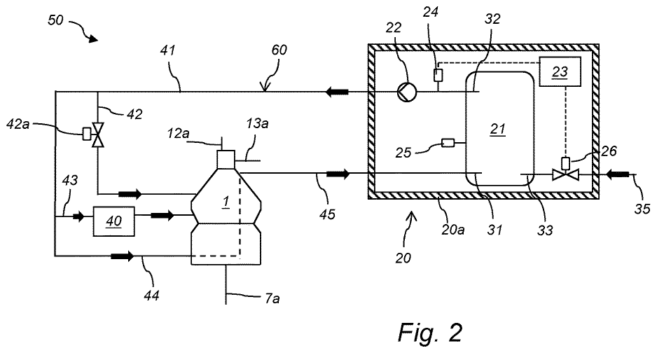

During operation of the separator in FIG. 1, the centrifuge bowl 10 is caused to rotate by torque transmitted from the drive motor 4 to the spindle 7. Via the stationary inlet pipe 7a (see FIG. 2), liquid mixture is supplied to the hollow spindle 7 and inlet 11. Thus, the liquid mixture to be separated is brought into the separation chamber within the centrifuge bowl 10 and further between the separation discs of the stack fitted in the separation chamber. A separated liquid light phase moves radially inwards between the separation discs and is discharged via the liquid light phase outlet 12 to the stationary outlet pipe 12a, whereas separated liquid heavy phase is discharged via the liquid heavy phase outlet 13 to the stationary outlet pipe 13a. Heavier components in the liquid mixture, e.g. sludge particles and/or heavy phase, move radially outwards between the separation discs and accumulate at the periphery of the separation space 21 at the sludge outlets 14.

Sludge is emptied intermittently from the sludge outlets 14 by supplying hydraulic fluid to the intermittent discharge system 30 from the OWM 40, whereupon sludge and a certain amount of fluid is discharged from the separation space by means of centrifugal force.

As also illustrated in FIG .1, there is a line, such as a pipe, for cooling water 44 extending into the centrifugal separator 1 below the centrifuge bowl. By means of channels 44a, cooling water may be supplied via line 44 to cool the gear box of the drive member 4 and then also cool the stationary hood. For this, the hood 2 may comprise a cooling jacket, such as a double wall, through which cooling channel 42a may extend. Water that has cooled the gear box of the drive member 4 and the hood 2 is collected in line, or pipe, 45.

The OWM 40 has also an inlet line 43 for water and there is also an inlet line 42 extending to a flushing member 17, such as a nozzle, that is arranged in the space 3 surrounding the centrifuge bowl 10. The nozzle 17 is thus arranged for flushing the surrounding space 3 with water, e.g. after a solids discharge from sludge outlets 14. FIG. 2 illustrates a centrifugal separation system 50 comprising the centrifugal separator 1 discussed in relation to FIG. 1 above. The system 50 further comprises a recirculation unit 20, that is arranged as a stand-alone, single unit outside of the separator 1. The recirculation unit comprises a support structure 20a, onto which a collection tank 21 and a pump 22 are arranged. The collection tank 21 is for holding for water that is to be supplied to the centrifugal separator 1 and the pump 22 is arranged for pumping water from the collection tank 21 to the centrifugal separator 1.

The centrifugal separation system 50 is arranged such that a circulation loop 60 for the water in the collection tank 21 is formed. This circulation loop 60 extends between the collection tank 21 and the stationary hood 2 of the centrifugal separator 1. In this example, the water of the circulation loop 60 is also used for cooling the gear box of the drive member of the centrifugal separator. Thus, the circulation loop comprises pipe 41 to which the pump 22 of the recirculation unit pumps water from the collection tank 21, and pipe 44, which extends from pipe 41 into a lower part of the separator 1 for first cooling the gear box and then the frame 2. The circulation loop further comprises the outgoing pipe 45 from the hood 2 that collects the water that has cooled the gear box and the frame 2. From pipe 45, the water is led back to the collection tank 21 of the recirculation system, i.e. outgoing pipe 45 is arranged to collect and return the cooling water back to the collection tank 21.

Further, via pipe 42 that branches off from pipe 41, water may be supplied to the flushing member 17 discussed in relation to FIG. 1 above. This may be regulated by valve 42a arranged in branched pipe 42. During normal operation, valve 42a is closed so that no water flows in pipe 42. However, when flushing of the surrounding space 3 is needed, valve 42a may be turned on in order to supply the flushing member 17 with pressurized water.

The intermittent discharge system 30 of the separator 1 is also connected to circulation loop 60. More specifically, the OWM 40 of the intermittent discharge system is coupled to the circulation loop via pipe 43 that branches off from pipe 41.

Water from the circulation loop 61 that has been used by the flush member 17 or the intermittent discharge system 30 is not reintroduced into the circulation loop.

The collection tank 21 of the recirculation unit 20 further comprises an inlet 33 for external water, such as for external tap water. Thus, the collection tank 21 may be completely refilled with external water if needed or the water level of the collection tank 21 may be increased by inflow of water via inlet 33. The collection tank may also comprise a further outlet (not shown) for disposing water in the tank 21 to e.g. a drain, i.e. for disposing water in the collection tank 21 to somewhere other than the circulation loop 61.

In this example, the recirculation unit 20 further comprises a temperature sensor 24 arranged for measuring the temperature of the water in the circulation loop 60. The recirculation unit has also a control unit 23 operable to control the inflow of external water to the collection tank 21 via the inlet 33 based on information from the temperature sensor 24. The control unit 23 may thus be configured to open and close valve 26 that is arranged at the inlet 33 for external water to the collection tank 21.

In order to control the opening and closing of the valve 26 based on temperature information from sensor 24, the control unit 23 may for example comprise a calculation unit which may take the form of substantially any suitable type of programmable logical circuit, processor circuit, or microcomputer, e.g. a circuit for digital signal processing (digital signal processor, DSP), a Central Processing Unit (CPU), a processing unit, a processing circuit, a processor, an Application Specific Integrated Circuit (ASIC), a microprocessor, or other processing logic that may interpret and execute instructions. The calculation unit may represent a processing circuitry comprising a plurality of processing circuits, such as, e.g., any, some or all of the ones mentioned above. The control unit 23 may further comprise a memory unit which provides the calculation unit with, for example, stored program code and/or stored data which the calculation unit needs to enable it to do calculations. The calculation unit may also be adapted to storing partial or final results of calculations in the memory unit. The memory unit may comprise a physical device utilised to store data or programs, i.e., sequences of instructions, on a temporary or permanent basis.

Thus, the control unit may be configured to perform the steps
d1) determining 110 the temperature t1 of the water to be resupplied to the centrifugal separator; and
d2) determining 111 if the temperature t1 is above a threshold value to and if so, supplying 112 external water to the collection tank 21 to lower the temperature of the water that is to be resupplied.

Moreover, the collection tank 21 may comprise a level sensor 25 for measuring the water level in the collection tank 21. This level sensor may also be connected to the control unit 23. Therefore, the control unit 23 may further be operable to control the inflow of external water to the collection tank 21 via the inlet 33 based on information from the level sensor 25.

Thus, the control unit may be configured to perform the steps
e) determining 107 the water level L1 in the collection tank 21;
f) determining 108 if the water level L1 is below a threshold value L0 and if so, supplying 113 external water to the collection tank 21 to increase the water level in the collection tank 21.

Thus, if water has been used by the flushing member 17 and the intermittent discharge system 30 so that the overall amount of water in the circulation loop 60 has decreased, this may be detected by the level sensor 25 so that external water may be supplied to the circulation loop, i.e. external water may be supplied via the inlet 33 to the collection tank 21.

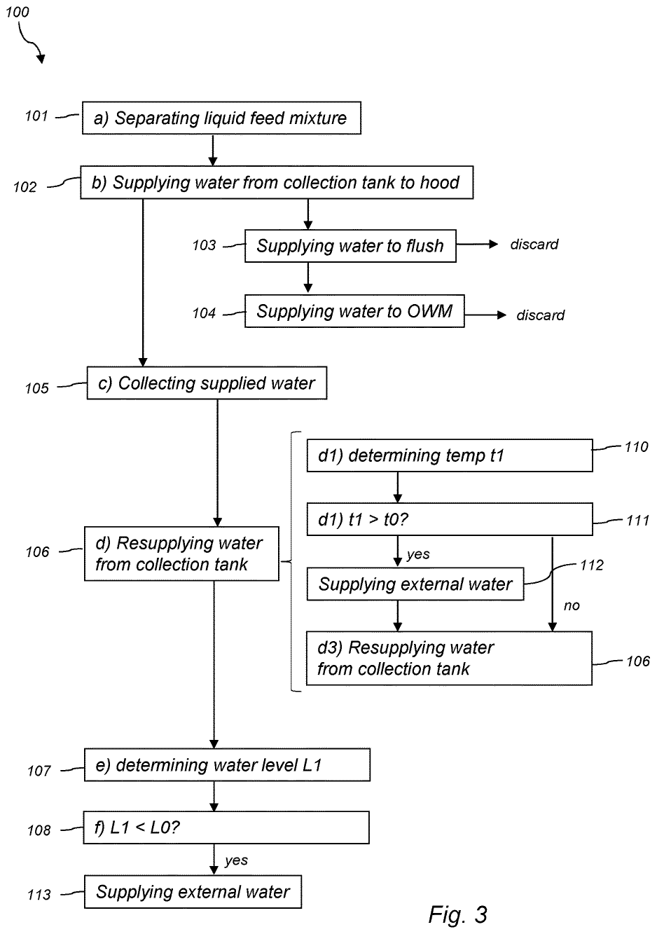

The method 100 of the present invention is further illustrated by the flow chart in FIG. 3.

The method 100 comprises step a) of separating 101 the liquid feed mixture into at least one separated liquid phase in the centrifuge bowl 10 and step b) of supplying 102 water from a collection tank 21 to the centrifugal separator 1 for cooling the stationary hood 2. This water is in the above example also used for cooling the gar box of the drive member of the centrifugal separator.

Step b) further comprises supplying 103 water to the centrifugal separator 1 from the circulation loop 60 to flush the surrounding space 3. This water supplied to flush the surrounding space 3 is not reintroduced in the circulation loop 60.

Step b) also comprises wherein supplying 104 water from the circulation loop to the intermittent discharge system 30 of the centrifugal separator. This water is then not reintroduced in the circulation loop 60.

The method further comprises a step c) of collecting 105 the supplied water from step b) in the collection tank 21 after cooling the stationary hood 2 and the gear box of the drive member of the centrifugal separator 1. This water may then be reused for further cooling of the hood 2 and the gear box of the drive member 4. Thus, the method further comprises a step d) of resupplying 106 water from the collection tank 21 to the centrifugal separator 1 for cooling the stationary hood 2 such that a circulation loop 60 of water is formed between the centrifugal separator 1 and the collection tank 21.

However, the temperature of the water may be controlled before it is returned to the centrifugal separator 1. Thus, step d) may comprises the sub steps of
d1) determining 110 the temperature t1 of the water to be resupplied;
d2) determining 111 if the temperature t1 is above a threshold value t0 and if so, supplying 112 external water to the collection tank 21 to lower the temperature; and then
d3) resupplying 106 water from the collection tank 21 to the centrifugal separator 1 for cooling the stationary hood 2.

Further, the overall water amount in the recirculation loop may also be checked, either continuously or e.g. at specific time intervals. The method 100 may thus comprise the steps of
e) determining 107 the water level L1 in the collection tank 21;
f) determining 108 if the water level L1 is below a threshold value L0 and if so, supplying 11) external water to the collection tank to increase the water level in the collection tank 21.

The invention is not limited to the embodiment disclosed but may be varied and modified within the scope of the claims set out below. The invention is not limited to the orientation of the axis of rotation (X) disclosed in the figures. The term “centrifugal separator” also comprises centrifugal separators with a substantially horizontally oriented axis of rotation. In the above the inventive concept has mainly been described with reference to a limited number of examples. However, as is readily appreciated by a person skilled in the art, other examples than the ones disclosed above are equally possible within the scope of the inventive concept, as defined by the appended claims.

1. A method of operating a centrifugal separator, wherein the centrifugal separator comprises
a centrifuge bowl arranged to rotate around an axis of rotation and in which a separation of a liquid mixture takes place,
a stationary hood which defines at least part of a surrounding space in which said centrifuge bowl is arranged,
a drive member configured to rotate the centrifuge bowl around the axis of rotation, wherein
the centrifuge bowl further comprises an inlet for receiving the liquid mixture to be separated and at least one liquid outlet for discharging a separated liquid phase,
wherein the method comprises the steps of:
a) separating the liquid feed mixture into at least one separated liquid phase in the centrifuge bowl;
b) supplying water from a collection tank to the centrifugal separator for cooling said stationary hood;
c) collecting the supplied water from step b) in said collection tank after cooling said stationary hood; and
d) resupplying water from the collection tank to the centrifugal separator for cooling said stationary hood such that a circulation loop of water is formed between the centrifugal separator and said collection tank.

2. The method according to claim 1, wherein the water supplied to the centrifugal separator in step b) is also used for cooling a portion of the drive member.

3. The method according to claim 1, wherein step b) further comprises supplying water to the centrifugal separator from said circulation loop to flush the surrounding space.

4. The method according to claim 3, wherein the water supplied to flush the surrounding space is not reintroduced in said circulation loop.

5. The method according to claim 1, wherein the centrifugal separator further comprises an intermittent discharge system for discharging a separated sludge phase from the centrifuge bowl to the surrounding space, and
wherein step b) further comprises supplying water from said circulation loop to said intermittent discharge system.

6. The method according to claim 5, wherein the water supplied to the intermittent discharge system is not reintroduced in said circulation loop.

7. The method according to claim 1, wherein step d) comprises the sub steps of:
d1) determining the temperature of the water to be resupplied;
d2) determining if the temperature is above a threshold value and if so, supplying external water to said collection tank to lower the temperature; and then
d3) resupplying water from the collection tank to the centrifugal separator for cooling the stationary hood.

8. The method according to claim 1, further comprising the steps of:
e) determining the water level in the collection tank; and
f) determining if the water level is below a threshold value and if so, supplying external water to said collection tank to increase the water level in said collection tank.

9. A centrifugal separation system for separating at least one liquid phase and a sludge phase from a liquid feed mixture, said separation system comprising a centrifugal separator and a recirculation unit; wherein the centrifugal separator comprises
a centrifuge bowl arranged to rotate around an axis of rotation and in which the separation of the liquid mixture takes place,
a stationary hood which defines at least part of a surrounding space in which said centrifuge bowl is arranged, and
a drive member configured to rotate the centrifuge bowl around the axis of rotation,
wherein the centrifuge bowl further comprises an inlet for receiving the liquid mixture to be separated and at least one liquid outlet for discharging a separated liquid phase, and
wherein the recirculation unit comprises:
a collection tank for water to be supplied to the centrifugal separator; and
a pump for pumping water from said collection tank to the centrifugal separator, and
wherein the centrifugal separation system is arranged such that a circulation loop for water is formed between the collection tank and the stationary hood of the centrifugal separator.

10. The centrifugal separation system according to claim 9, wherein the centrifugal separator further comprises a flushing member for flushing said surrounding space, and wherein the flushing member is connected to said circulation loop.

11. The centrifugal separation system according to claim 9, wherein the centrifugal separator further comprises an intermittent discharge system for discharging a separated sludge phase from the centrifuge bowl to the surrounding space, and
wherein the intermittent discharge system is connected to said circulation loop.

12. The centrifugal separation system according to claim 9, wherein the collection tank comprises an inlet for external water and the recirculation unit further comprises a temperature sensor arranged for measuring the temperature of the water in the circulation loop and a control unit operable to control the inflow of external water to the collection tank via said based on information from the temperature sensor.

13. The centrifugal separation system according to claim 9, wherein the collection tank comprises an inlet for external water and a level sensor, and
wherein the recirculation unit further comprises a control unit operable to control the inflow of external water to the collection tank via said inlet based on information from said level sensor.

14. The centrifugal separation system according to claim 9, wherein the recirculation unit is a stand-alone, single unit.

15. The centrifugal separation-system system according to claim 14, wherein the stand-alone, single unit comprises a support structure onto which the pump and collection tank is arranged.

16. The method according to claim 2, wherein step b) further comprises supplying water to the centrifugal separator from said circulation loop to flush the surrounding space.

17. The method according to claim 2, wherein the centrifugal separator further comprises an intermittent discharge system for discharging a separated sludge phase from the centrifuge bowl to the surrounding space, and
wherein step b) further comprises supplying water from said circulation loop to said intermittent discharge system.

18. The method according to claim 3, wherein the centrifugal separator further comprises an intermittent discharge system for discharging a separated sludge phase from the centrifuge bowl to the surrounding space, and
wherein step b) further comprises supplying water from said circulation loop to said intermittent discharge system.

19. The method according to claim 4, wherein the centrifugal separator further comprises an intermittent discharge system for discharging a separated sludge phase from the centrifuge bowl to the surrounding space, and
wherein step b) further comprises supplying water from said circulation loop to said intermittent discharge system.

20. The method according to claim 2, wherein step d) comprises the sub steps of:
d1) determining the temperature of the water to be resupplied;
d2) determining if the temperature is above a threshold value and if so, supplying external water to said collection tank to lower the temperature; and then
d3) resupplying water from the collection tank to the centrifugal separator for cooling the stationary hood.
